(19) United States
(12) Patent Application Publication
(10) Pub. No.: US 2017/0174361 A1
(43) Pub. Date: Jun. 22, 2017

(54) Illumination System for a Kiteboarding Kite

(71) Applicant: Michael Thielvoldt, Martinez, CA (US)

(72) Inventor: Michael Thielvoldt, Martinez, CA (US)

(21) Appl. No.: 15/384,316

(22) Filed: Dec. 19, 2016

Related U.S. Application Data
(60) Provisional application No. 62/269,933, filed on Dec. 19, 2015.

(51) Int. Cl. B64D 47/04; F21V 31/00; F21V 23/04; B63B 45/02; F21V 21/08; B63B 35/79; B63B 35/85; B64C 31/06; F21V 14/00

(52) U.S. Cl. CPC B64D 47/04; B64C 31/06; F21V 31/005; F21V 23/0492; F21V 14/00; F21V 21/0816; B63B 35/7973; B63B 35/85; B63B 45/02; B64C 2031/065

(57) ABSTRACT

An illumination system for a kiteboarding kite that senses the position and orientation of the kite with respect to a rider and directs a beam of light at the rider's path. The illumination system is battery powered and mounted to a kiteboarding kite with an inflated leading edge. A processor executed program analyzes data from several sensors, such as accelerometers, gyroscopes and magnetometers, in order to quickly adjust the direction of a spotlight and avoid shining light into the rider's eyes. In addition, the illumination system may also illuminate the rider directly or areas of the kite.

### CROSS-REFERENCE

This application claims the benefit of U.S. Provisional Application No. 62/269,933, filed Dec. 19, 2015, which application is incorporated herein by reference.

### GOVERNMENT INTEREST

The invention was not made by any government agency or under a contract with any government agency, federal or otherwise.

### TECHNICAL FIELD

The following relates generally to sporting equipment, and more particularly to lighting equipment for use in sports activities, and even more particularly, to lights for use in kiteboarding.

### BACKGROUND OF THE INVENTION

In the sport of kiteboarding, a rider is tethered to a kite with high-strength lines that both pull the rider and allow the rider to steer the kite. The rider stands on a board, and using the kite to harness the motive power of wind, the rider is pulled along a surface such as water, snow or solid ground.

Many kiteboarders enjoy exploring new frontiers in which to kiteboard, from mountaintops to mountain lakes, from windy deserts to stormy seas. One frontier that is presently being explored is the temporal territory of night. Intrepid individuals will attach glow sticks and strips of LEDs onto kites and venture onto lakes and rivers in the darkness. These improvised innovations make the kite itself visible, but the areas around the rider remain hard to see. Where other sports make use of headlamps to illuminate the way, headlamps cause objects near the rider to reflect brightly, reducing the rider's ability to see comparatively dimly lit objects farther away. Many headlamps can also be knocked off the rider's head when the rider falls.

Accordingly, there remains a need for an illumination device that would allow a kiteboarder to ride at night aware of her surroundings and not totally reliant on headlamps.

### SUMMARY OF THE INVENTION

In general, a kite-mounted illumination system is provided for use in the performance of kiteboarding using a leading-edge inflatable kite at night. The illumination system attaches to the kite, is battery-powered, and includes a programmed processor, an inertial sensor, and one or more directional light sources, and is configured to create a pool of light in the path of a rider who is kiteboarding in low-light conditions. Also discussed are embodiments of a waterproof housing arrangement that protects and supports the components, and provides attachment features for affixing the illumination system to the kite. The implementation details of the directional light sources distinguish between three particularly preferable embodiments, each possessing particular advantages over the other.

In the first preferred embodiment, a directable light source is provided that produces a beam with controllable direction. This allows the system to direct the beam to advantageous locations in a continuous manner as the rider moves. While several directable light sources may be provided, a single directable light source is versatile, so rider may be well served with even a single directable light source of sufficient luminous power. In this aspect, the processor is programmed to analyze the data from the inertial measurement and configured to send signals to mechanisms that direct the light source toward the rider's path.

In the second preferred embodiment, the directable light source is replaced by two or more directional light sources that produce a beam of fixed direction with respect to the kite, at least one directed to the left of the kite's plane of symmetry and at least another directed to the right. In this aspect, the processor is programmed and configured to direct power to the light source that best illuminates the rider's surroundings, once again based on the inertial sensor data. Additionally, the system reduces the brightness of an individual light source when maneuvering of the kite directs that light source away from the rider's path.

In a third preferred embodiment, two or more directional light sources are housed separately within different containers so that each container houses its own separate light source, battery, processor and inertial sensor, thus creating an illumination system involving several individually-packaged, individually-powered and individually-controlled directional lights that can be attached separately on different parts of the kite and individually oriented so that their light beams are fixed with respect to the kite to shine toward different areas around the rider. In this aspect, each processor is programmed to analyze data from the inertial sensors to determine the orientation and motion of the kite and configured to control the brightness of the light source within the same housing so that the light source is brightest when the rider's path intersects its light beam.

In another aspect, which applies to all light source arrangements, additional light sources are also powered by the battery and directed at the kite in order to increase the visibility of the kite itself.

In another aspect, the use of accelerometers, gyroscopes and magnetometers are also discussed as a way to approximate the orientation and motion of the kite and is applicable to all light arrangements.

### BRIEF DESCRIPTION OF THE DRAWING

FIG. 1: A perspective view of a rider kiteboarding and illumination system directing a light beam onto the rider's path according to one embodiment

FIG. 2: A perspective view of movable optic and actuator

FIG. 3: A perspective view of a preferred embodiment of an actuator for a movable optic

FIG. 4: A perspective view of the Illumination system and its components according to one embodiment with several, immovable light sources

FIG. 5: A perspective view of a rider holding a kite at azimuth and an illumination system producing light beams around rider according to one embodiment

FIG. 6: A perspective view of a rider holding a kite at azimuth and an illumination system producing light beams around the rider and on the kite according to one embodiment

FIG. 7: Block diagram of program for processor according to one embodiment

FIG. 8: A perspective view of a rider kiteboarding and illumination system with two separate housings directing a beam of light onto the rider's path according to one embodiment

FIG. 9: A perspective view of the Illumination system and its components according to one embodiment with two housings

FIG. 10: Perspective view of rider and kite showing several kite positions and light beam directions according to one embodiment

FIG. 11: Perspective view of rider and kite showing relative height of left wingtip and right wingtip and several light beam directions according to one embodiment

FIG. 12: Block diagram of program part for processor according to one embodiment

FIG. 13: Block diagram of program part for processor according to alternative embodiment

FIG. 14: Dual-angle polar graph of relative directions typical of kite in center range of positions

FIG. 15: Dual-angle polar graph of relative directions typical of kite in far-right

### DEFINITIONS AND SPECIAL TERMS

The following terms are defined as follows, in so far as these definitions are consistent with at least one common meaning.

Kiteboarding Kite: A heavier-than-air human-controlled tethered flying airfoil that imparts motive power to a human user through tension in a tether using wind as its primary power source in order to propel the user across a surface.

Optic: any of the elements (as lenses, mirrors, or light guides) of an optical instrument or system

A/an: at least one.

Azimuth position: A kite position where the kite is flying with control-lines taught centered above the rider, facing directly into the wind in a sheeted-out (pitched-forward) position. This is a common resting-position used by kiteboarders.

Rotational Stage: a collection of structures that move together in a limited number of degrees of freedom.

### DETAILED DESCRIPTION OF THE INVENTION

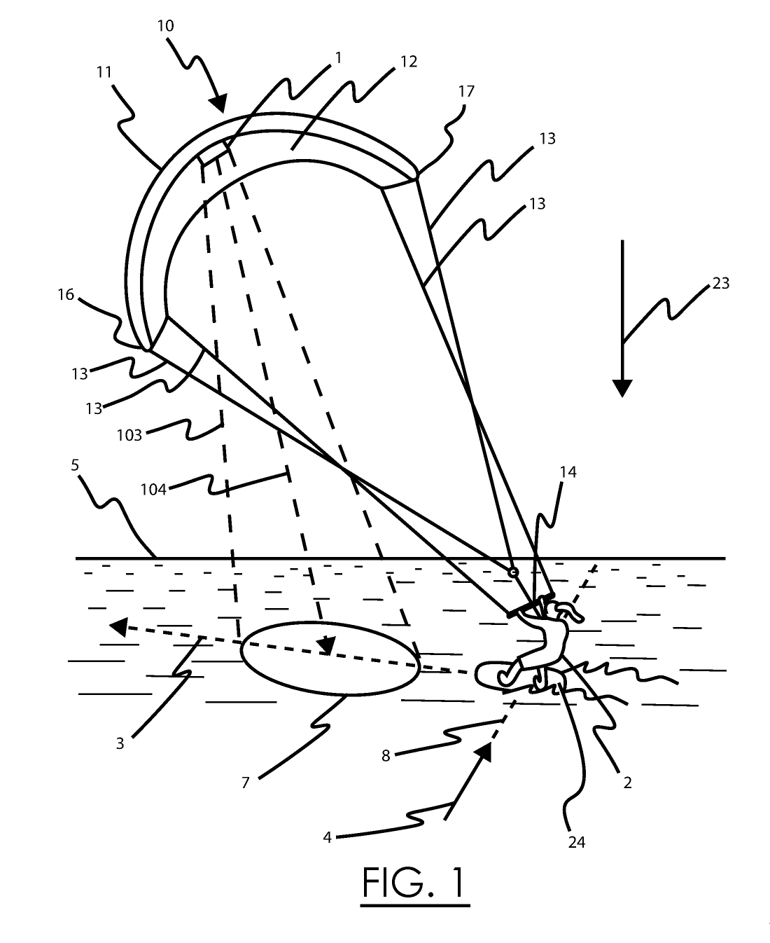

### FIG. 1: Use Scenario

FIG. 1 generally depicts one anticipated use of a an illumination system 1 for a kiteboarding kite 10 showing a rider 2 moving along a path 3 across the surface 5 of a body of water. The illumination system 1 shines a light beam 103 with a direction 104 that intersects with the rider's path 3, thus creating a pool of light 7 on the water surface ahead of the rider 2 so that the rider's path 3 is illuminated. In this embodiment, the pool of light 7 does not cover the area under the rider, which may be preferred in order to prevent blinding the rider while still allowing the rider to see obstructions in her path. In other embodiments, it may be desirable to extend the pool of light to include the area under the rider for showmanship or safety.

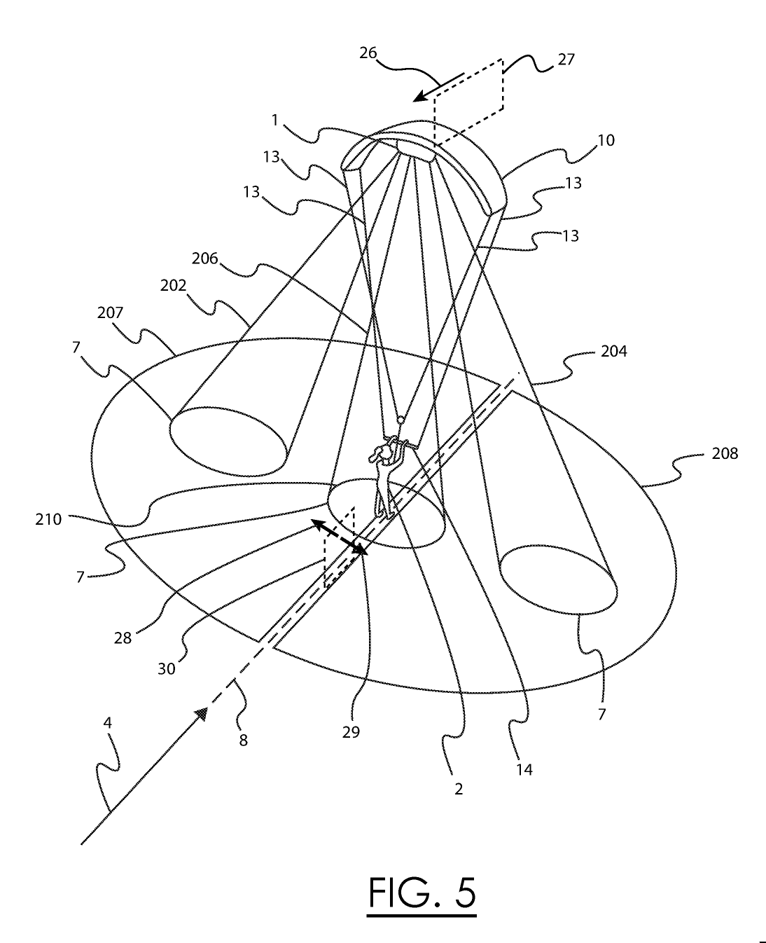

The shape of the kiteboarding kite 10 usually approximates an airfoil shape whereby when the kite moves in a forward direction 26 (shown in FIG. 5) the air first passes over a leading edge 11 then passes over a canopy 12, thus enabling the kite to generate lift in the presence of wind and propel the rider 2 across a surface 5. The surface 5 is often the surface of a body of water, but may also include the surface of an area covered by snow, sand, dirt, grass, ice, pavement, wood or any other solid or liquid material. Many kiteboarding kite designs feature an inflatable leading edge 11 that contain a bladder for holding air at a positive pressure relative to ambient air pressure. Generally, a rider 2 is attached to the kite 10 by kite lines 13 that convey a motive force on the rider and also allow the rider to steer the kite by moving the control bar 14. The kite lines 13 are symmetrically attached to the kite 10 so that, as viewed when facing the kite from the leading edge 11, at least one kite line 13 is attached to the left side of the kite at the left wingtip 16 and at least one kite line 13 is attached to the right side of the kite at the right wingtip 17. Additional kite lines 13 may be attached to the leading edge 11 directly or indirectly through a bridle system.

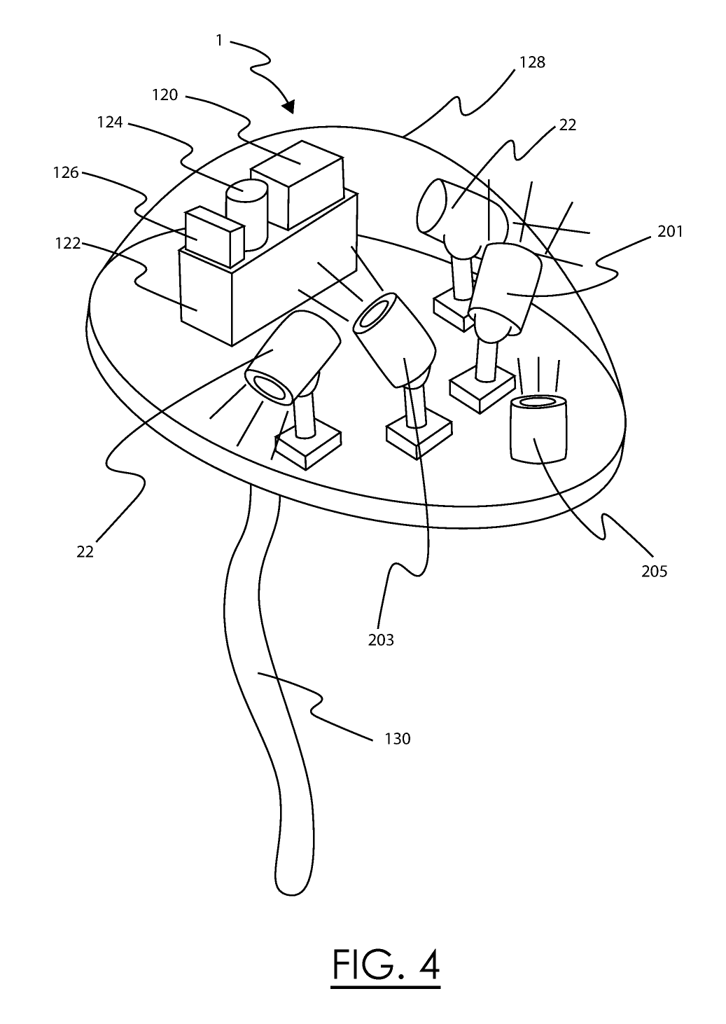

Like other sailing sports, the steering inputs required to follow a particular path 3 are largely determined by the direction of the wind 4. FIG. 5 shows a rider 2 holding a kite 10 at azimuth with an illumination system 1 that produces pools of light 7 around the rider. The rider 2 generally faces downwind, and the rider can fly the kite 10 in a three-dimensional region downwind of herself. Given an imaginary line 8 that passes through the rider and has the same direction as the wind direction 4, the rider's area is bisected by a plane 30 that is coincident with both imaginary line 8 and the direction of gravity 23 (shown in FIG. 4). The rider 2 will generally move to her left when the kite 10 is positioned on the rider's left side 28, as defined by the region 207 that is left of plane 30, or move to her right when the kite 10 is positioned on the rider's right side 29, as defined by the region 208 to the right of plane 30. Therefore, the illumination system 1 may direct a pool of light 7 onto a rider's path 3 by sensing whether the kite 10 is on the rider's left side 28 or right side 29.

### Discussion: A First Preferred Embodiment of the Illumination System

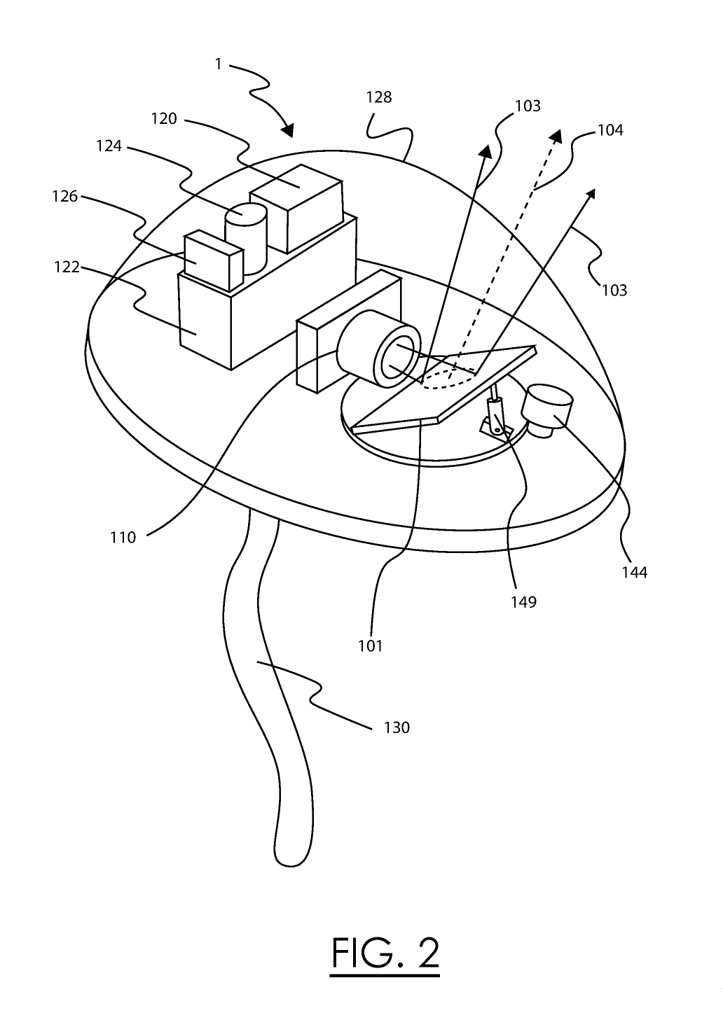

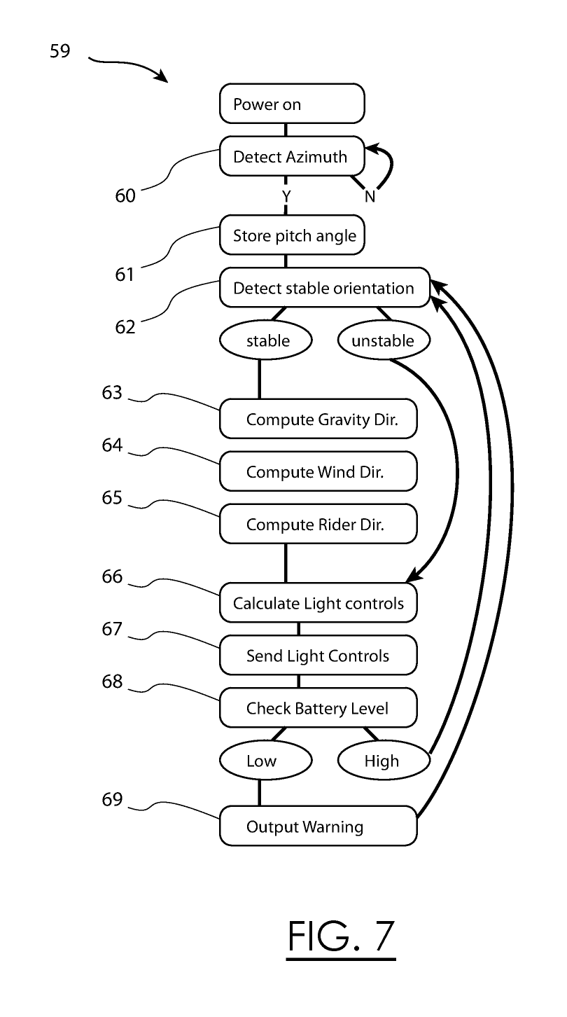

A first preferred embodiment of an illumination system for a kiteboarding kite that illuminates the rider's path is shown in FIG. 2 as an example. Various alternatives may also be possible. In this first preferred embodiment, the illumination system 1 features a light control circuit 122 which is electrically connected to a battery 120, a processor 124 and an inertial sensor 126. This embodiment of the illumination system also features a single light emitter 110 that is configured to emit a light beam 103 onto a movable optic 101 that can be moved in at least two degrees of freedom by an inner stage electric motor 149 and an outer stage electric motor 144. The light control circuit 122 is configured to send electrical control signals to the motors 149 and 144 in order to adjust the position of a movable optic 101, thereby controlling the light beam direction 104. This embodiment also features a waterproof housing 128 with a clear cover that protects the components, provides a base for configuration of the illumination system components and also provides a strap 130 for mounting the entire system to the kiteboarding kite 10. In a preferred embodiment, the inertial sensor 126 so that it can detect the orientation and motion of the kite. The inertial sensor may include accelerometers, tilt sensors, gyroscopes, or may additionally be paired with a magnetometer. The processor 124 is configured to receive data from the inertial sensor 126 and is enabled by the program 59 (described in further detail in FIG. 7) to analyze that data and send signals to the electric motors 144 and 149 to move the optic 101, thereby directing the light beam 103 toward the rider's path 3.

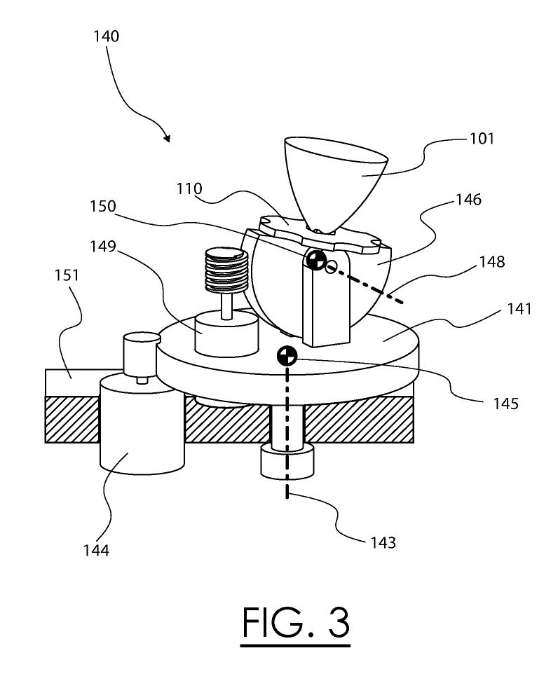

In order to direct the light beam 103 toward the rider's path 3 as kite moves, the illumination system 1 must be capable of adjusting the orientation of the movable optic 101 in at least two degrees of freedom. A preferred actuation mechanism 140 for the movable optic 101 is shown in FIG. 3, and features two nested rotating stages. The outer rotating stage 141 is pivotally mounted on a base surface 151 within the illumination system 1 and motivated to rotate about an outer stage rotational axis 143 by an outer stage electric motor 144. The inner rotating stage 146 is nested within the outer rotating stage 141 so that the inner rotating stage 146 also rotates about the outer stage rotational axis 143. The inner rotating stage 146 is pivotally mounted within the outer rotating stage 141 and motivated to rotate about an inner stage rotational axis 148 by an inner stage electric motor 149. In this embodiment, the light emitter 110 and movable optic 101 are both mounted on the inner rotating stage 146. Ideally, both the inner and outer stages are balanced so that the center of mass of the inner stage 150 is substantially coincident with the inner stage rotational axis 148, and the center of mass of the outer stage 145 is substantially coincident with the outer stage rotational axis 143 so that an externally applied force on the actuator 140 that results in a purely linear acceleration of the entire actuator mechanism does not generate substantial torques on the inner and outer stage electric motors 149, 144.

### Discussion: A Second Preferred Embodiment of the Illumination System

A first preferred embodiment of an illumination system for a kiteboarding kite that illuminates the rider's path is shown in FIG. 4 as an example. Various alternatives may also be possible. In this second preferred embodiment, the illumination system 1 features a light control circuit 122 which is electrically connected to a battery 120, a processor 124 and an inertial sensor 126. This embodiment of the illumination system also features a left-facing directional light 201 that produces a left-facing beam 202 within the area left of the rider 207 (shown in FIG. 5) and a right-facing directional light 203 that produces a right-facing beam 204 within the area right of the rider 208 (shown in FIG. 5). As before, the inertial sensor 126 is immovable and unrotatably attached to the kite 10, in this embodiments through the mounting system provided by a waterproof housing 128, and senses orientation and position of the kite 10. The processor 124 is configured to receive data from the inertial sensor 126 and is enabled by the program 59 (described in further detail in FIG. 7) to analyze that data and thereby activate either the left-facing directional light 201 or the right-facing directional light 203, thereby enabling the illumination system 1 to produce either a left-facing beam 202 or a right-facing beam 204 depending on the direction of the rider's motion 3.

In addition to illuminating the rider's path 3, the illumination system 1 may also produce a spotlight to illuminate the rider herself. FIG. 4 also shows a center-facing directional light 205 that produces a center-facing beam 206 (shown in FIG. 5) which shines directly at the rider and creates a pool of light 210 (shown in FIG. 5) that intersects the imaginary line 8. FIG. 5 also shows the plane of the symmetry of the kite 27. If the illumination system 1 is mounted such that it intersects the kite's plane of symmetry 27, a single light that is immovably and unrotatably mounted within the illumination system 1 that is directed at the rider 2 will always illuminate the rider 2 regardless of the orientation of the kite 10.

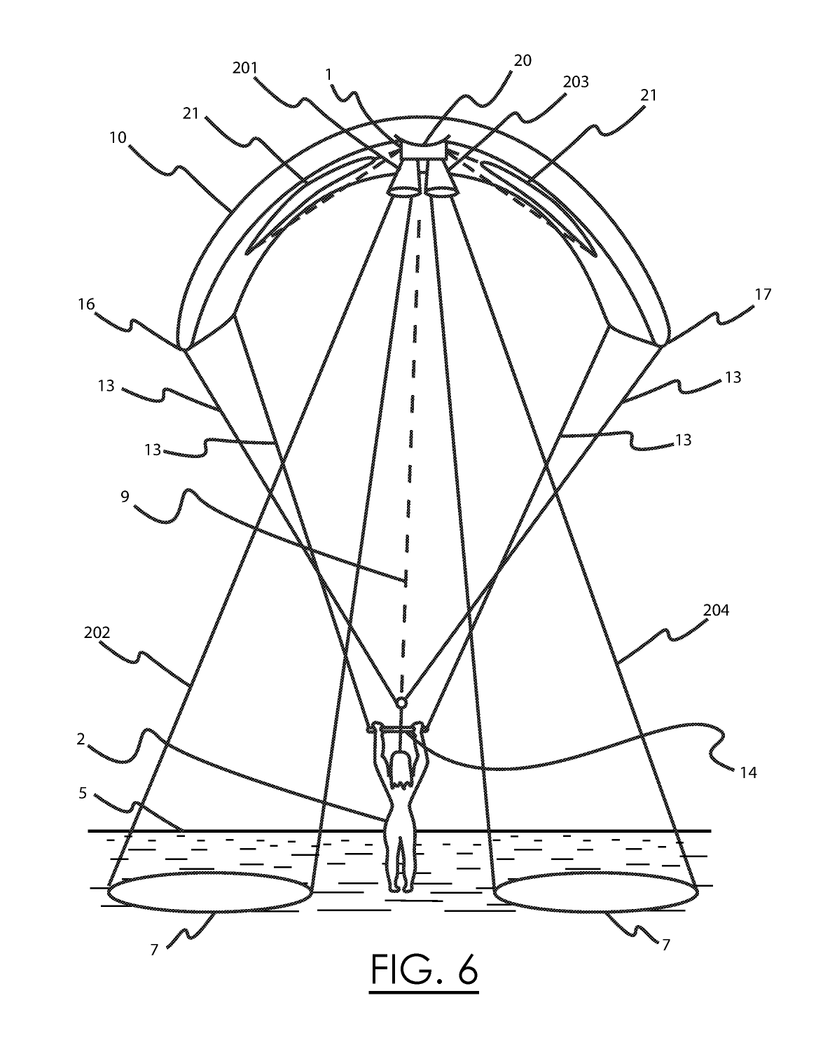

The rider may also want to illuminate the kite itself, for showmanship or safety. As an example of an illumination system that also illuminates the kite, FIG. 4 shows an embodiment of the illumination system 1 that features two kite-facing light sources 22. The resulting illumination pattern is shown FIG. 6. The kite-facing light sources 22 may be configured to illuminate a second portion of the kite 21 when the illumination system is attached to a first portion of the kite 20. FIG. 6 also illustrates an imaginary line 9 between the illumination system 1 and the rider 2.

### Discussion: A Third Preferred Embodiment of the Illumination System

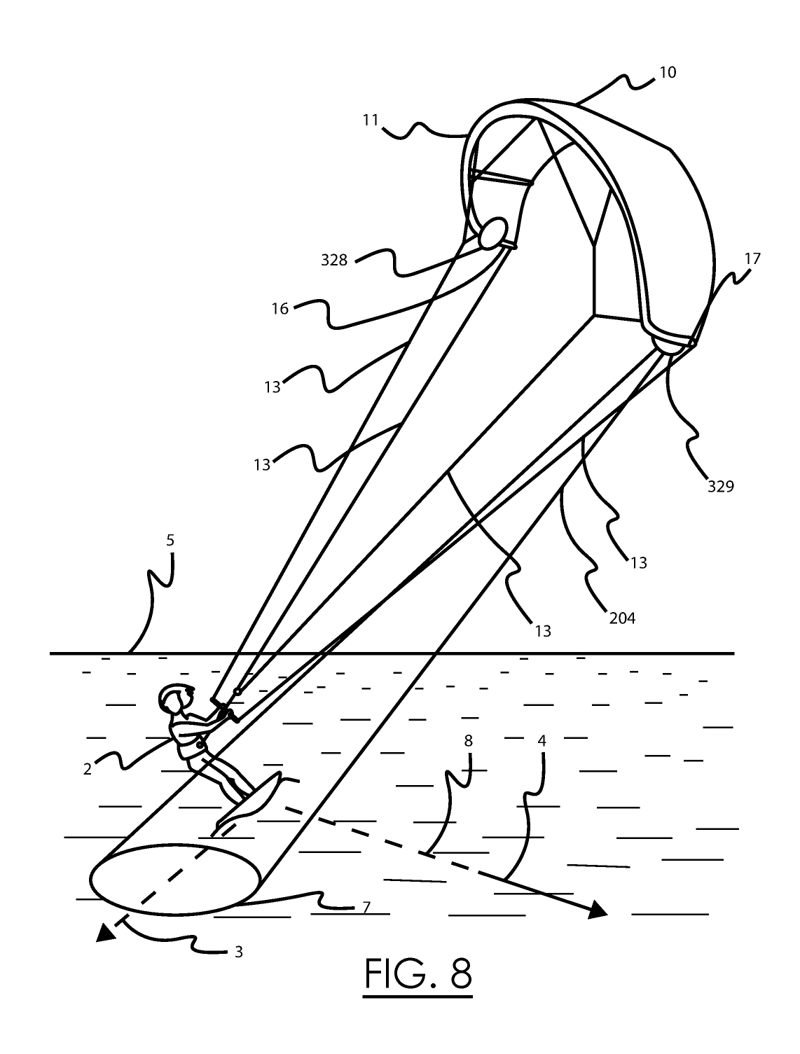

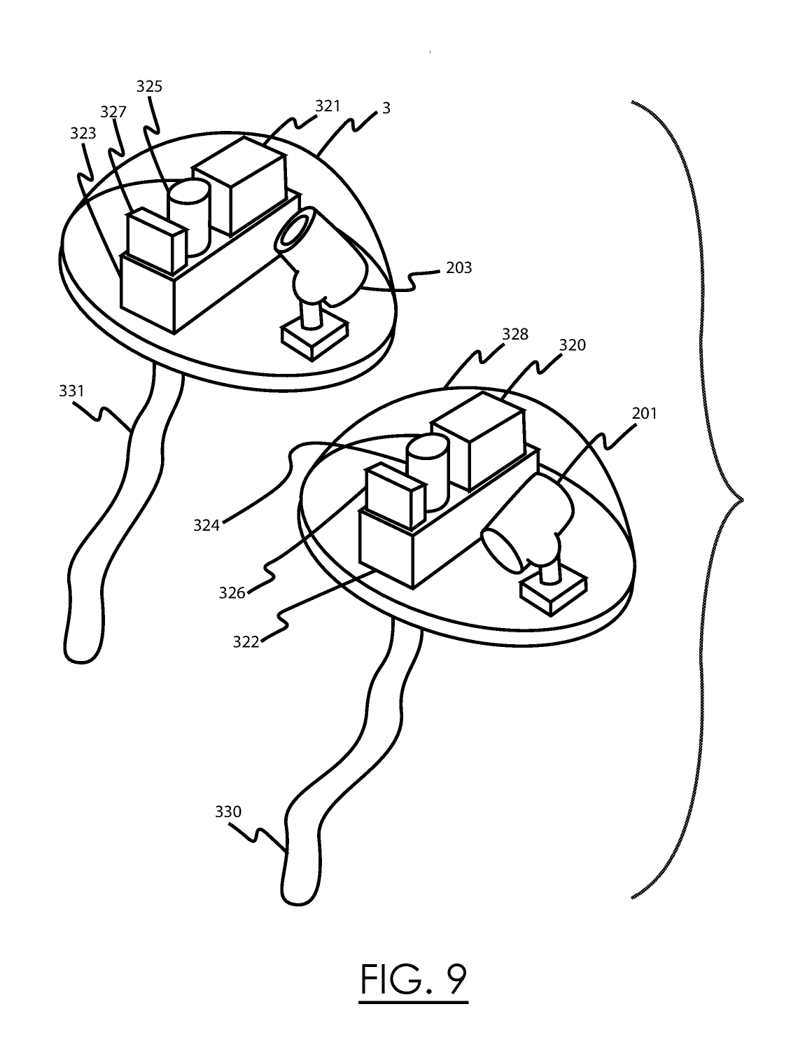

A third preferred embodiment of an illumination system for a kiteboarding kite that illuminates the rider's path is shown in FIG. 8 as an example. Various alternatives may also be possible. In this third preferred embodiment, the illumination system 1 features two independently powered controlled light sources contained within two separate housings 328 and 329 that can be mounted separately on the kite 10. As shown in FIG. 8, the light source contained within housing 329 may be mounted on the right wingtip 17 and the light source contained within housing 328 may be mounted on the left wingtip 16. When the rider 2 is riding along a path 3 to his right side, the light source on the right wingtip 17 may be configured to produce a right-facing beam 204 and the light source on the left wingtip 16 may be configured to produce no light beam. As shown in FIG. 9, the first light source features a first battery 320, a first light control circuit 322, a first processor 324, a first inertial sensor 326 and a left-facing directional light 201 contained within a first waterproof housing 328 that also features a first strap 330 for mounting the light source to the kite 10. The second light source features a second battery 321, a second light control circuit 323, a second processor 325, a second inertial sensor 327 and a right-facing directional light 203 contained within a second waterproof housing 329 that also features a second strap 331 for mounting the light source to the kite 10. As before, each of the inertial sensors 326 and 327 are immovably and unrotatably attached to the kite 10, in these embodiments through the mounting system provided by a waterproof housings 128 and 329 (respectively), and are each able to sense the orientation and motion of the kite 10 and send the sensor data to the corresponding processor 324 or 325. Each processor 324, 325 is configured to receive data from the corresponding inertial sensor 326,327 and is enabled by the program 59 (described in further detail in FIG. 7) to analyze the inertial data and thereby either activate or deactivate the corresponding directional light 201, 203 within the same housing, thereby illuminating the rider's path.

### Kite Orientation Tracking

In the following section we discuss a set of program methods that give the processor the capability to interpret the inertial sensor data to produce useful control signals for controlling either the actuator stages or the brightness of lights with fixed orientations.

Various general-purpose software libraries are available for converting raw inertial sensor data into useful formats for interpretation. One such example can be found at: http://x-io.co.uk/open-source-imu-and-ahrs-algorithms/, and is included herein as a reference. Another reference is found here: https://www.arduino.cc/en/Tutorial/Genuino101CurieIMUOrientationVisualiser and is also included herein as a reference.

The goal of the program is to determine with reasonable accuracy when a set of conditions regarding either the orientation or position of the kite is met at any given time, and compute the desired control signals. The preferred particular condition, and the form of the control signals to be computed will correspond to the embodiment.

In order for the system to be capable of determining whether meaningful conditions are met by the kite's position or orientation, we provide a way to calculate the direction of gravity, the direction of the rider and the direction of the wind in the kite's reference frame. It must be understood that all of these calculations will result in useful approximations, not exact figures. For simplicity we discuss the sensor axes as oriented in FIG. 5. The preferred way to calculate the three reference directions: gravity, rider, and wind is first to identify when the kite is in a position favorable for the calculation.

The best time to calculate the reference directions of gravity, the rider, and the wind is when the kite has a relatively unchanging orientation relative to the rider. Fortunately, kiteboarders spend much time flying their kites in relatively unchanging orientations because this is favorable for going upwind. The processor may be programmed to record the angular velocity values from a 3-axis gyroscope, and when all 3 angular velocities have remained sufficiently close to zero for an amount of time, the kite may be said to have an unchanging orientation. At such a moment, the direction of gravity may be measured by vector-summing the recorded translational acceleration measurements. Determining the wind direction may be derived from the direction of gravity by assuming that the wind direction 4 will be orthogonal to the direction of gravity 23, and will also lie within the kite's plane of symmetry 27. These two assumptions, in combination, allow the calculation of the wind direction as the intersection line between the kite's plane of symmetry and the horizon, not shown as the gravity direction conveys this information. The directionality of this line can be assumed to point towards the nose of the kite. The assumption about the wind being horizontal will be valid primarily for kiteboarding on horizontal surfaces, which is common. The rider direction may also be assumed to be in the kite's plane of symmetry 27, and at an angle with respect to the wind direction which is measured as discussed in the program discussion, an assumption that will only be valid for a particular kite flying in a moment with unchanging orientation, the condition we identified.

Turning to FIG. 14, we see a double-angle graph of the computed directions from the kite's frame of reference in a situation representative of the kite being in the center range 109 of positions. The center of the graph 40 represents the direction towards the rider when the kite is in azimuth position 6. The rider's direction at any given time may be not exactly in the center because the kite may be sheeted in. As mentioned in the definitions, we define the azimuth position 6 as including the kite being sheeted out. The vertical axis represents the plane of the kite's symmetry 27. The wind direction is item 4, the kite's forward direction item 26. The rider direction is 9. We see that the light direction 104 has been computed as slightly downwind, meaning past the rider direction 9 away from the wind direction 4 along the plane of symmetry 27.

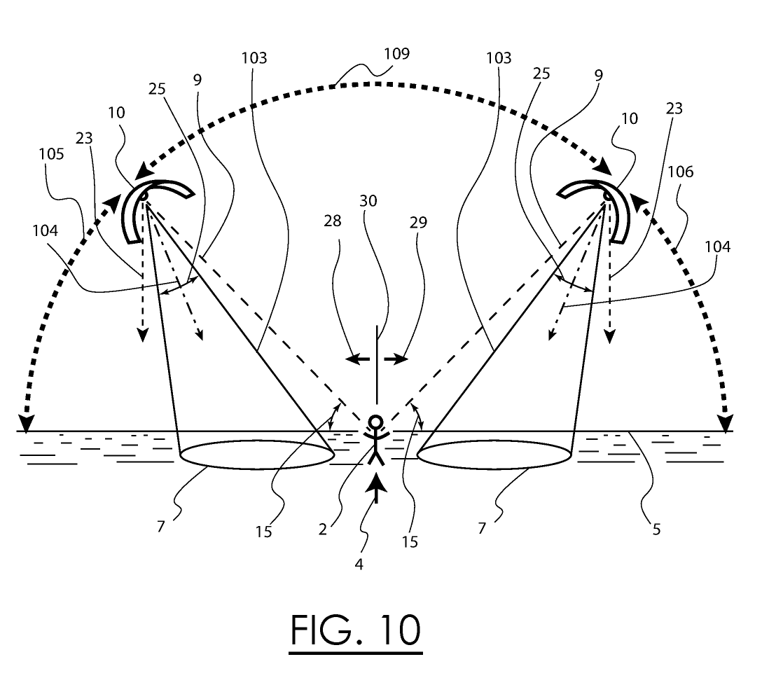

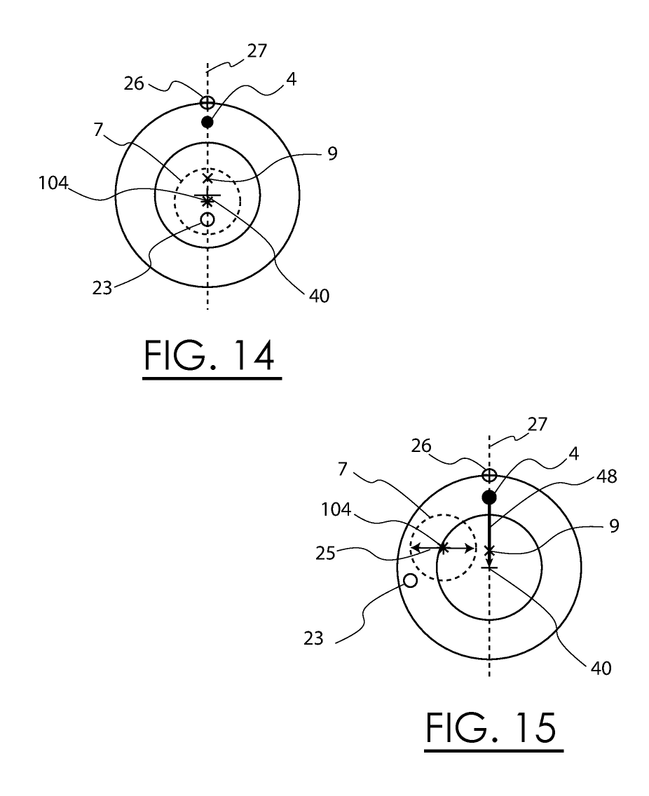

In the first embodiment, the processor will preferably be programmed to determine what range of positions the kite is within at any moment. We will choose to consider three ranges of positions as shown in FIG. 10: a far-left range 105, a far-right range 106, and a center-range 109. FIG. 15 shows a representation of the far-right range, which may be identified by the gravity direction 24 being to the right of an imaginary line 48 pointing from the wind direction to the center of the graph and at least 45 degrees from the center of the graph 40. Note that the direction of the imaginary line matters for distinguishing far-left from far-right. 45 degrees is chosen because a human eye has a visual field of approximately 60 degrees superior (up) so it would be inconvenient to have a kite shining light at a rider when it is this low in the sky. Visual field reference: “Review of Ophthalmology: Expert Consult”—Online and Print By William B. Trattler, Peter K. Kaiser, Neil J. Friedman.

In order to test an illumination system for this behavior, a rider may maneuver a kite dramatically at 45 degrees off the horizon or lower 15 and simply observe if the light hits their control bar.

The control signal for the first embodiment takes the form of set of two rotational coordinates indicating the light beam direction 104 with respect to the inertial sensor coordinates. Having previously computed the wind direction 4, gravity direction 24, and rider direction 9, and having integrated subsequent kite rotations, the subsequent kite rotations can be applied in reverse to the previously computed wind direction 4, gravity direction 24, and rider direction 9 to determine these directions in the current reference frame of the kite. Having also determined which range of positions the kite is presently in, the processor can now determine an appropriate direction 104 for the light beam.

If the kite is in the center-range 109 of positions, then the preferred direction for the light 104 is near the rider's direction 9, but slightly opposite the wind direction 4 from the rider, so that the light illuminates the rider, but is centered slightly downwind of the rider, which is where the rider most often faces when the kite is in the center-range.

Turning to FIG. 15, we see a double-angle graph of the computed directions in a situation representative of the kite being in the far-right range 105 of positions. If the kite is in either the far-left range 105 or far-right range 106 of positions, then the preferred direction for the light 104 is a balance between the rider direction 9, the gravity direction 24, and the wind direction, and slightly more than half the beam's subtended angle 25 from the rider's direction 9. This will place the light pool 7 to the side of the rider that the kite is flying on and upwind of the kite 10, and will also direct the light beam far enough from the rider to prevent the light beam from hitting the rider or her control bar 14 directly. This is a preferable direction because when the kite is within the far-left range 105 the rider will most often be traveling to the left, edging with her board into the wind against the pull of the kite lines 13 as shown in FIG. 1. In the far-left range of positions, the kite will also most often be in the rider's field of view, making it highly advantageous to direct the beam to not hit the control bar 14 so as to not impair the rider's vision. The same principles apply when the kite is in the far-right range of positions.

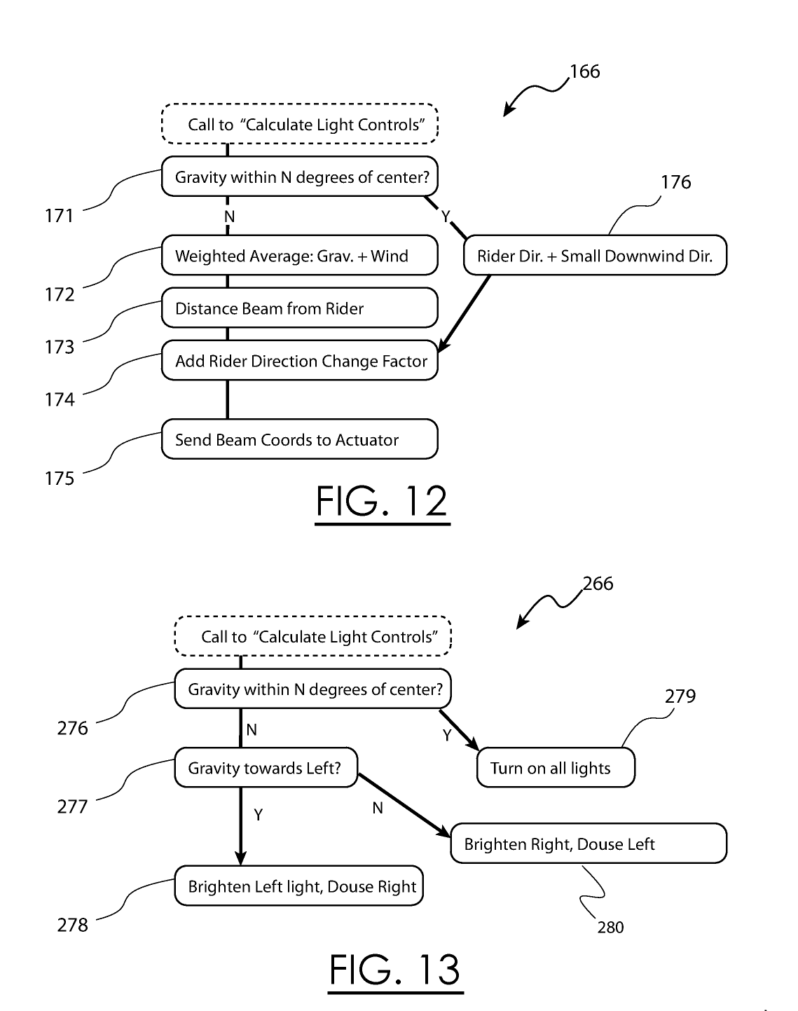

The processor may be programmed to detect when the rider changes her direction of motion 3. Accelerations in the upwind and downwind directions that do not correspond to a kite maneuver can be assumed to be the rider changing direction using her board 24 and body position. These accelerations can be detected by applying a rotational transformation to the translational acceleration data to take the acceleration component aligned with the wind direction. This scalar value may be continuously monitored for upwind-directed and downwind-directed accelerations. Turning to FIG. 12, when a significant upwind-directed acceleration is detected, the beam direction 104 may be adjusted 174 further towards the wind. Conversely, when a significant downwind-directed acceleration is detected, the beam direction 104 may be adjusted further away from the wind. In this manner, the system is made capable of redirecting the light beam 104 in response to the rider changing their direction of motion 3, thereby directing light more exactly where the rider needs it.

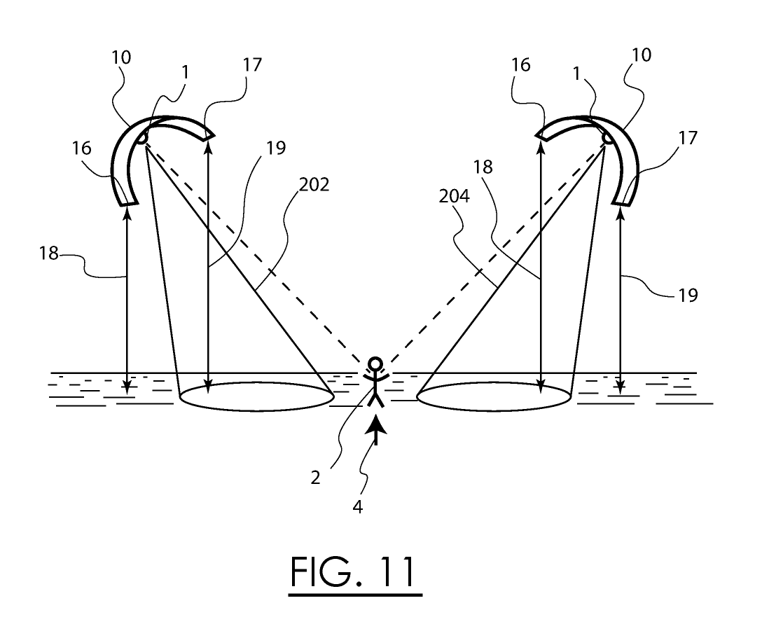

Turning to FIG. 11, in the second embodiment, the processor will preferably be programmed to determine the relative altitudes 18, 19 of the kite's wingtips 16, 17 and distinguish between the three conditions: right wingtip significantly lower, left wingtip significantly lower, neither wingtip significantly lower than the other as shown in FIG. 5. These conditions may be distinguished computationally by assessing 277 if the gravity direction 23 is to the right or the left of the kite's plane of symmetry 27. If the left wingtip is lower, the left-facing beam 202 is illuminated, and the right-facing beam 204 is doused. Of course, for operability, the right-facing beam is illuminated and the left-facing beam doused when the right-wingtip is lower.

### Program

The above calculations may be implemented in a program 59 as shown in FIG. 7. Immediately following power-on, the processor may wait to detect azimuth conditions 60. Once azimuth is detected, the processor measures and records the its pitch-angle, as determined against gravity, for use later in determining the rider direction 9. At this point, the program enters a continuous loop, wherein it tests for a stable kite orientation 62. If the kite orientation is unstable, the processor proceeds to calculate the light control data 66 according to either 166 or 266, depending on the embodiment. With the control data calculated, the processor outputs light control signals 67, and proceeds to check the battery level 68. If the battery is low, the processor produces a visual warning 69 to the rider. The warning may be a timed on-off sequence, a change of color a change of brightness, or any other attention-getting event. We hereby disavow a parade of elephants for this step. After outputting this warning, the processor returns to the test for a stable kite orientation and repeats the sequence. If the processor detects a stable orientation, the processor proceeds as detailed above to compute an updated gravity direction 63, compute an updated wind direction 64, and compute an updated rider direction 65. It then proceeds with step 66 as before.

Step 66 should be implemented according to the particular embodiment of the lights. FIG. 12 shows a program segment 166 that will work for a type of movable light beam. First, the processor tests in step 171 if the gravity direction 23 is within a predetermined number of degrees of the direction of the rider measured at azimuth 9. This number of degrees is selected according to the rider's field of view, and may be 45 degrees, 50 degrees, 55 degrees, 60 degrees, or 65 degrees. If the test is passed, the processor computes a light beam direction that is substantially towards the rider, but preferably slightly downwind 176. If the test is failed, the processor computes a light beam direction 172 that blends the gravity direction, and the wind direction. It then modifies 173 this beam direction by constraining it to a calculated angular displacement from the rider direction. Next, the processor adds 174 an upwind or downwind component to the beam direction based on the rider's estimated recent changes in direction. Now with the beam direction calculated, the processor sends 175 command signals to the actuator.

FIG. 13 shows a program segment 260 according to one implementation of light controls calculation 66 of the program 59. In this segment, three conditions are distinguished, which makes the system capable of controlling at least a left-facing, right-facing and center-facing directional lights 201, 203, 205. First, the processor tests in step 276 if the gravity direction 23 is within a predetermined number of degrees of the direction of the rider measured at azimuth 9. This number of degrees is selected according to the rider's field of view, and may be 45 degrees, 50 degrees, 55 degrees, 60 degrees, or 65 degrees. If the test is passed, the processor turns on all lights 279. If the test is failed, the processor tests 277 if the gravity direction is towards the left of the kite's center plane 30. If this test is passed, the left light 201 is illuminated, and the right light is doused as part of program step 278. Also this step would douse the center-facing light 205 if one is present. If this test is failed, the right-facing light 203 would be illuminated and the left-facing and center-facing lights would be doused in step 280.

The degree of accuracy desired for angular computations depends primarily on the light beam's subtended angle 110. A beam with a wide angle is more forgiving of inaccuracy. In general, a third of the beam's subtended angle 110 also commonly referred to as the beam width, is a good guideline for the accuracy required. For example, for a subtended angle of 30 degrees, a 10 degree accuracy would be sufficient.

What is claimed is:

1. An illumination system for a kiteboarding kite having an inflatable leading edge chamber, a single-surface fabric canopy and being tethered to a rider by a plurality of kite lines, at least two of the lines being connected to a control bar at an end distal from the kite, which the rider manipulates, the illumination system comprising:
at least one battery attached to the kite,
a light control circuit attached to the kite and energized by at least one of the battery;
a processor that is electrically connected to the light control circuit;
a program that the processor is configured to execute;
an inertial sensor that is configured to send signals to the processor and is immovably and unrotatably affixed to the kite;
a light emitter attached to the kite and energized by at least one of the battery;
A movable optic comprising at least one light-directing surface that cooperates with the light emitter to produce a light beam having a light beam direction;
an actuator that is energized by at least one of the battery and is physically coupled to the optic and capable of moving the optic with respect to the kite and configured to receive control inputs from the light control circuit;
wherein the processor, the program, the actuator, and the optic, in cooperation, are capable of changing the light beam direction with respect to the kite in response to signals produced by the inertial sensor.

2. The illumination system of claim 1 wherein the inertial sensor comprises an accelerometer and a gyroscope.

3. The illumination system of claim 2 wherein the processor, as enabled by the program, is capable of determining based on signals from the inertial sensor if the kite is within a range of positions far-left of the rider with respect to the wind direction;
and wherein the processor, as enabled by the program, is capable of determining based on signals from the inertial sensor if the kite is within a range of positions far-right of the rider with respect to the wind direction;
and wherein the system is capable of continuously directing the light beam to the left of the rider when the kite is within a the range of positions far-left of the rider with respect to the wind direction;
and wherein the system is capable of continuously directing the light beam to the right of the rider when the kite is within a the range of positions far-right of the rider with respect to the wind direction.

4. The illumination system of claim 3 wherein the system is capable of directing the light beam so that the light beam does not hit the control bar when the kite is flown at incline angles of 45 degrees or less.

5. The illumination system of claim 1 wherein the illumination system is capable of redirecting the light beam in response to the rider changing their direction of motion.

6. The illumination system of claim 1 further comprising:
a waterproof housing containing the battery, light control circuit, processor, light emitter, optic, and actuator, and
a strap that secures the housing to the kite.

7. The illumination system of claim 1 additionally comprising a kite-facing light source attached to a first portion of the kite and directed toward a second portion of the kite, whereby the system is capable of illuminating the second portion of the kite.

8. The illumination system of claim 1 wherein the processor, as enabled by the program, is capable of monitoring the battery voltage and wherein the illumination system is configured to produce a visual warning upon detecting a low-battery condition.

9. The illumination system of claim 1 wherein the actuator comprises an outer rotating stage and an inner rotating stage nested within the outer rotating stage, and wherein the inner stage is pivotally mounted on at least one inner stage bearing and motivated to rotate about an inner stage rotational axis by an inner stage electric motor, and the outer stage is pivotally mounted on at least one outer stage bearing and motivated to rotate about an outer stage rotational axis by an outer stage electric motor, and wherein both the inner and outer stages are balanced so that the center of mass of the inner stage is substantially coincident with the inner stage rotational axis, and the center of mass of the outer stage is substantially coincident with the outer stage rotational axis, whereby a force external to the actuator that accelerates the actuator translationally, will not generate substantial torques on the inner and outer stage electric motors.

10. The illumination system of claim 9 additionally comprising a magnetometer electrically connected to the processor.

11. An illumination system for a kiteboarding kite having an inflatable leading edge chamber, a single-surface fabric canopy, a left wingtip and a right wingtip and being attached to a rider by a plurality of kite lines, at least two of the lines being connected to a control bar at an end distal from the kite, which the rider manipulates, the illumination system comprising:
at least one battery attached to the kite;
a light control circuit attached to the kite and energized by at least one of the battery;
a processor that is electrically connected to the light control circuit;
a program that the processor is configured to execute;
an inertial sensor that is configured to send signals to the processor and is immovably and unrotatably affixed to the kite;
at least one left-facing directional light un-movably and un-rotatably attached to the kite that produces a left-facing beam that is directed to an area to the left of the rider when the kite is oriented into the wind and positioned at azimuth;
at least one right-facing directional light un-movably and un-rotatably attached to the kite that produces a right-facing beam that is directed to an area to the right of the rider when the kite is oriented into the wind and positioned at azimuth;
wherein the processor receives signals from the inertial sensor that indicate the orientation of the kite;
wherein the light control circuit independently controls the brightness of the left-facing and right-facing directional lights;
wherein the processor as enabled by the program and the inertial sensor is capable of changing the relative brightness of the left-facing and right-facing directional lights in response to a change in the orientation of the kite.

12. The illumination system of claim 11 wherein the inertial sensor comprises an accelerometer and a gyroscope.

13. The illumination system of claim 12 wherein the processor, as enabled by the program, is capable of determining if the left wing-tip is at a significantly lower altitude than the right wing tip based on signals from the inertial sensor, and in response, maintaining the left-facing directional light at a higher brightness than the right-facing directional light;
and wherein the processor, as enabled by the program, is capable of determining if the right wing-tip is at a significantly lower altitude than the left wing tip based on signals from the inertial sensor, and in response, maintaining the right-facing directional light at a higher brightness than the left-facing directional light;

14. The illumination system of claim 13 wherein the left-facing and the right-facing directional lights are each oriented so that neither the left-facing beam nor the right-facing beam is capable of hitting the control bar while the kite is flying at azimuth.

15. The illumination system of claim 14 further comprising a center-facing directional light un-movably and unrotatably attached to the kite that produces a center-facing beam that is directed to an area that intersects an imaginary line through the rider in the direction of the wind when the kite is oriented into the wind at azimuth.

16. The illumination system of claim 11 further comprising:
a waterproof housing that contains the battery, the light control circuit, the processor, the left-facing directional light, the right-facing directional light, and the inertial sensor;
strap that secures the housing to the kite.

17. The illumination system of claim 11 additionally comprising a kite-facing light source attached to a first portion of the kite and directed toward a second portion of the kite, whereby the system is capable of illuminating the second portion of the kite.

18. The illumination system of claim 11 wherein the processor, as enabled by the program, is capable of monitoring the battery voltage and producing a visual warning upon detecting a low-battery condition.

19. The illumination system of claim 13 additionally comprising a magnetometer electrically connected to the processor.

20. An illumination system for a kiteboarding kite having an inflatable leading edge chamber, a single-surface fabric canopy, a left wingtip and a right wingtip and being attached to a rider by a plurality of kite lines, at least two of the lines being connected to a control bar at an end distal from the kite, which the rider manipulates, the illumination system comprising:
a first battery attached to the kite,
a first light control circuit attached to the kite and energized by the first battery;
a first processor that is electrically connected to the first light control circuit;
a first program that the first processor is configured to execute;
a first inertial sensor that is configured to send signals to the first processor and is immovably and unrotatably affixed to the kite;
a left-facing directional light un-movably and un-rotatably attached to the kite and energized by the first light control circuit, that produces a left-facing beam that is directed to an area to the left of the rider when the kite is oriented into the wind and positioned at azimuth;
a first waterproof housing that contains the first battery, the first light control circuit, the first processor, the first inertial sensor, and the left-facing directional light,
a first strap capable of securing the first waterproof housing to the kite;
a second battery attached to the kite,
a second light control circuit attached to the kite and energized by the second battery;
a second processor that is electrically connected to the second light control circuit;
a second program that the second processor is configured to execute;
a second inertial sensor that is configured to send signals to the second processor and is immovably and unrotatably affixed to the kite;
a right-facing directional light un-movably and un-rotatably attached to the kite and energized by the second light control circuit, that produces a right-facing beam that is directed to an area to the right of the rider when the kite is oriented into the wind and positioned at azimuth;
a second waterproof housing that contains the first battery, the second light control circuit, the second processor, the second inertial sensor, and the right-facing directional light,
a second strap capable of securing the second waterproof housing to the kite;
wherein the first processor as enabled by the first program and the first inertial sensor is capable of changing the brightness of the left-facing directional light in response to a change in the orientation of the kite
wherein the second processor as enabled by the second program and the second inertial sensor is capable of changing the brightness of the right-facing directional light in response to a change in the orientation of the kite.
